(19) United States
(12) Patent Application Publication
(10) Pub. No.: US 2007/0212161 A1
(43) Pub. Date: Sep. 13, 2007

(54) Pool tile cleaning device and method

(76) Inventor: Karen A. Carlson, New Smyrna Beach, FL (US)

Correspondence Address: EDWARD M. LIVINGSTON, PA, 963 TRAIL TERRACE DRIVE, NAPLES, FL, 34103, US

(21) Appl. No.: 11/371,659

(22) Filed: Mar. 8, 2006

(51) Int. Cl. A46B 11/06; A47L 13/22; B43K 5/00

(52) U.S. Cl. 401/289; 401/270; 401/205

(57) ABSTRACT

A pool tile cleaning device (1) having a hollow handle (2) and a cleaning head (3) on a distal end (20). The handle (2) acts as a cleaning product reservoir (25) and is attached to the cleaning head (3). The cleaning head (3) has a scrubbing means (5) located thereupon in order to effectively remove dirt and grime from pool tiles. The device (1) is gravity fed and provides a continuous distribution of cleaning product through the handle (2) to the cleaning head (3). A metering valve (17) is located at the distal end of the handle (20), behind the cleaning head (3), so as to control the amount of cleaning product that is distributed onto the cleaning head (3). A purge valve (10) is used in conjunction with the device (1) to permit air to enter the reservoir (25) as the cleaning product exits the reservoir (25).

### BACKGROUND OF THE INVENTION

This invention relates to pool tile cleaning devices, more specifically, a pool tile cleaning device that is easy to use, may be used underwater and provides a continuous flow of soap during use.

Currently, in order to thoroughly clean tiles located on one's pool, such as glazed ceramic tile pieces located in the vertical area of swimming pools, a person usually uses cleanser or cleaning fluid and a scrub brush attached to an elongated pole to scrub debris off of the tiles. As the cleanser/cleaning fluid is used up, the more difficult it becomes to thoroughly clean the tiles as the person cleaning the tiles must apply greater physical strength to the brush to compensate for the diminishing amount of cleanser/cleaning fluid. Thus, not only is it a difficult and tedious chore to scrub the tiles themselves, but the need to constantly reapply cleanser/cleaning fluid to the brush is required. However, the need to constantly reapply the cleanser/cleaning fluid is time-consuming as one must interrupt his or her cleaning stride, apply more cleanser/cleaning fluid to the scrub brush and return to the cleaning location and continue scrubbing.

In addition, because liquid soap readily disperses when the scrub brush is inserted into the water, many individuals are currently combining muriatic acid with soap to form a gel that will adhere better to the scrub brush. However, this is an unsafe practice.

Although there are some devices for cleaning pool tiles, none are effective in providing a continuous distribution of cleanser or cleaning fluid.

Thus, the need exists for a pool tile cleaning device which thoroughly cleans tiles and provides a continuous and uniform distribution of cleanser or cleaning fluid.

The relevant prior art includes the following patents:

| Patent No. | | |
|---|---|---|
| (U.S. unless stated | | |
| otherwise) | Inventor | Issue Date |
| 3,080,590 | Mullinix et al. | Mar. 12, 1963 |
| 4,955,748 | Krumholz | Sep. 11, 1990 |
| 2,770,828 | Ellman | Nov. 20, 1956 |
| 5,634,232 | Brenneman | Jun. 03, 1997 |
| 5,735,620 | Ford | Apr. 07, 1998 |
| 5,361,442 | Payne et al. | Nov. 08, 1994 |
| Des. 372,570 | Dokos | Aug. 06, 1996 |
| Des. 381,208 | Collett | Dec. 09, 1997 |

### SUMMARY OF THE INVENTION

The primary object of the present invention is to provide a pool tile cleaning device that thoroughly cleans pool tiles.

A further object of the present invention is to provide a pool tile cleaning device that is easy to use.

An even further object of the present invention is to provide a pool tile cleaning device that provides a continuous flow of cleanser or cleaning fluid.

A further object of the present invention is to provide a pool tile cleaning device that is durable.

An even further object of the present invention is to provide a pool tile cleaning device that is easy to clean.

Another object of the present invention is to provide a pool tile cleaning device that permits a person to select the rate of flow of the cleanser or cleaning fluid that is to be used.

An even further object of the present invention is to provide a pool tile cleaning device that may be used by professional pool cleaners or home owners.

The present invention fulfills the above and other objects by providing a pool tile cleaning device having of a hollow handle and a cleaning head attached to a distal end of the handle. The handle acts as a cleaning product reservoir and is attached to the cleaning head. The cleaning head has a scrubbing means located thereupon in order to effectively remove dirt and grime from pool tiles. A metering valve is located on handle, behind the cleaning head, to control the amount of cleaning product that is distributed onto the cleaning head. A purge valve is used in conjunction with the present invention to allow air to enter the cleaning product reservoir to replace the amount of cleaning product that is distributed onto the cleaning head.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side plan view of the present invention;

FIG. 2 is a perspective view of a cleaning head of the present invention;

FIG. 3 is a front view of the cleaning head of the present invention;

FIG. 4 is a cross-sectional view along line 4-4 of the embodiment of FIG. 1 of a purge valve of the present invention;

FIG. 5 is a downward-looking view of a purge valve of the present invention;

FIG. 6 is an upward-looking view of a purge valve of the present invention;

FIG. 7 is a side view of a metering valve of the present invention; and

FIG. 8 is a perspective view of the present invention in use.

### DESCRIPTION OF THE PREFERRED EMBODIMENTS

For purposes of describing the preferred embodiment, the terminology used in reference to the numbered components in the drawings is as follows:
1. pool tile cleaning device
2. handle
3. cleaning head
4. water hose
5. scrubbing means
6. cleaning product pathway
7. cleaning head first section
8. cleaning head second section
9. support device
10. purge valve
11. threads
12. purge valve top cap
13. plate
14. purge valve bottom cap
15. rod
16. spring
17. metering valve
18. aperture
19. handle proximal end
20. handle distal end
21. pool tile
22. flow reducer
23. water
24. pool edge
25. reservoir

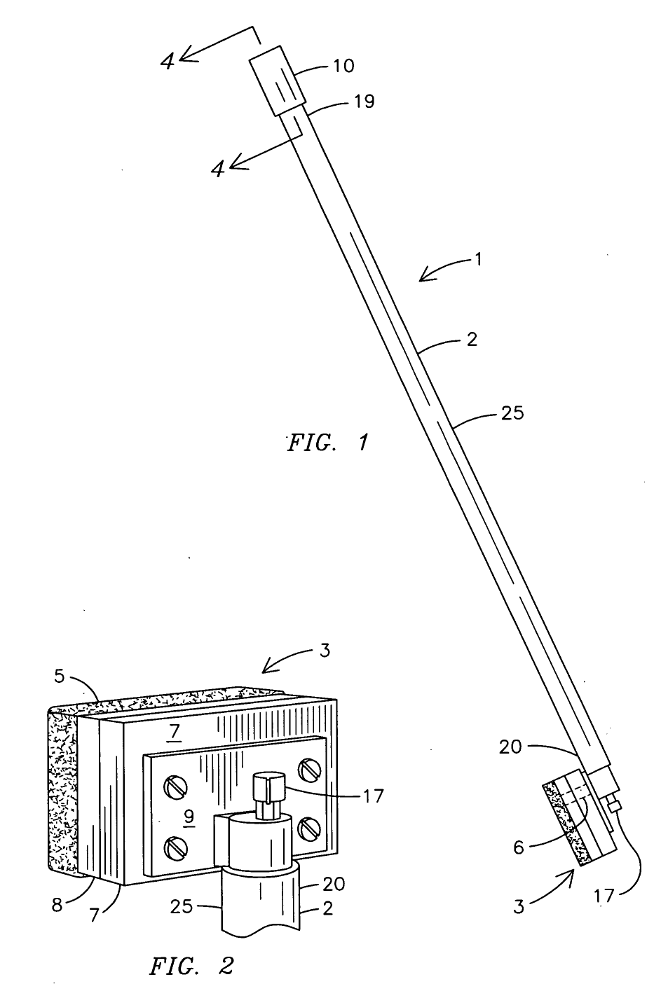

With reference to FIG. 1, a side plan view of the present invention 4 is shown. The pool tile cleaning device 1 includes an elongated handle 2 having a distal end 21 that is attachable to a cleaning head 3 and a proximal end 20 that is preferably attachable to a purge valve 10. Because the handle 2 is hollow, a reservoir 25 is created for holding cleanser/cleaning fluid that is to be used when cleaning pool tiles. A cleaning product pathway 6 connects the handle 2 to the cleaning head 3 so as to permit the cleaning product to be distributed onto the cleaning head 3. A metering valve 17 is located on the distal end of the handle 20, behind the cleaning head 3, so as to permit a user to control the amount of cleanser/cleaning fluid that is exited from the handle 2 and distributed onto the cleaning head 3. The purge valve 10 is secured to the handle proximal end 19 and permits air to enter the reservoir 25 when depressed to replace the amount of cleanser/cleaning fluid that is distributed onto the cleaning head 3. Because the handle 2 is long, a user need not get onto his/her hands and knees in order to clean the pool tiles. He or she may stand upright or slightly hunched over the pool and place the cleaning head 3 such that it is flush against the pool tiles to be cleaned and move the pool tile cleaning device 1 in an up and down, side to side motion. Because the pool tile cleaning device 1 is gravity-fed, meaning that the cleanser/cleaning fluid will naturally flow towards the cleaning head 3 during use, the operator may transport the pool tile cleaning device 1 in a position such that the cleaning head 3 is above the handle 2 without the cleanser/cleaning fluid exiting the pool tile cleaning device 1. Thus, so long as the metering valve 17 is at least partially open, cleanser/cleaning fluid will flow onto the cleaning head 3 when the reservoir 25 is located above the cleaning head 3. As the cleanser/cleaning fluid is depleted, the flow will decrease and the user can maintain the desire cleanser/cleaning fluid flow by adjusting the metering valve 17.

Next, FIG. 2 shows a perspective view of a cleaning head 3 of the present invention. The cleaning head 3 includes a support device 9, a cleaning head first section 7, a cleaning head second section 8 and a scrubbing means 5. The support device 9 secures the cleaning head 3 to the handle 2. The support device 9 may provide for a stationary or pivoting cleaning head 3 so as to permit a user to utilize the present invention at various angles. The cleaning head first section 7 is preferably made of a rigid material, preferably plastic, so as to provide a sturdy base for the cleaning head second section 8. The cleaning head second section 8 is preferably made of a somewhat flexible material, such as foam, so as to allow for some flexibility while the pool tile cleaning device is in use. The scrubbing means 5, which is preferably a scrubbing pad which is replaced once a month, allows for the removal of dirt and grime from the pool tiles. Although a scrubbing pad is shown as the scrubbing means 5, various other materials, which may be rigid or flexible, such as bristles, may also be used.

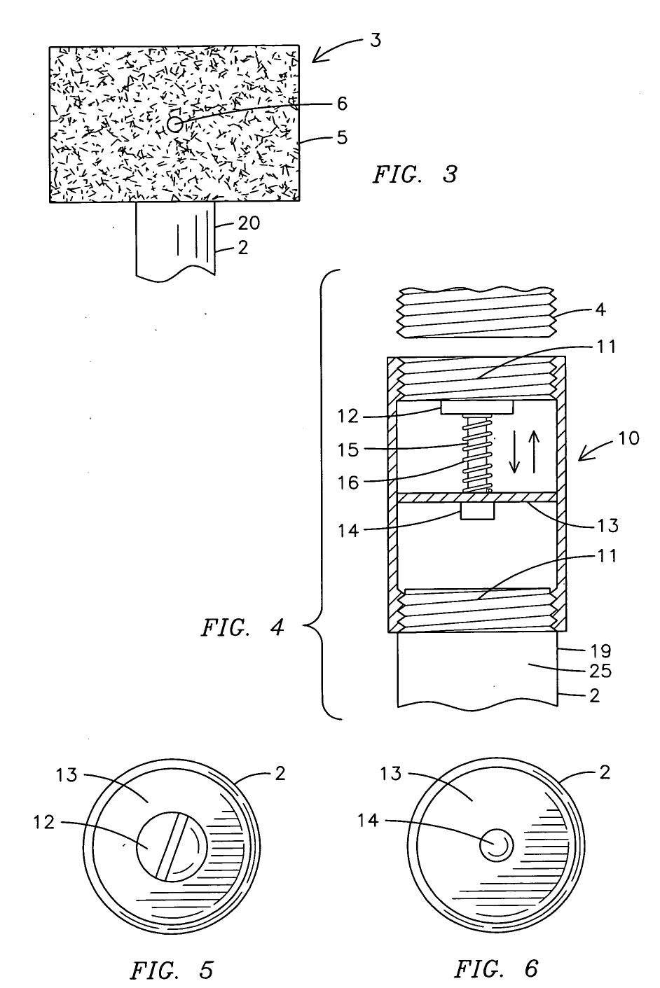

FIG. 3 shows a front view of the cleaning head 3 of the present invention. The cleaning product pathway 6 ends on the cleaning head 3 such that the cleaning product/water solution is distributed onto the cleaning head 3. Because the user will be moving the pool; tile cleaning device 1, the cleaning product will be spread over the pool tiles. In addition, because the cleaning product is distributed directly onto the cleaning head 3, the cleaning product is not wasted.

In FIG. 4, a cross-sectional view along line 4-4 of the embodiment of FIG. 1 of a purge valve 10 of the present invention is shown. The purge valve 10 is connected to the handle 2 so as to permit air to enter the reservoir 25 as cleanser/cleaning fluid is deposited onto the cleaning head 3. When the purge valve top cap 12 is pressed, the purge valve top cap 12 will become adjacent to a centrally-located plate 13, thereby permitting air to enter the reservoir 25. The purge valve 10 includes a rod 16 and spring 15 that permit the purge valve top cap 12 and purge valve bottom cap 14 to return to the original starting position when the purge valve top cap 12 is no longer pressed. In addition, the purge valve 10 includes internal threads 11 on either end that allow for the connection of a handle 2 and water hose 4.

In order to clean the reservoir 25, a water hose 4 is secured to the purge valve 10. When the water faucet connected to the water hose 4 is turned on, the water pressure flows through the reservoir 25 so as to remove any excess cleanser/cleaning fluid that may have dried within the reservoir 25. The purge valve 10 may be constructed of a predetermined material that does not leave marks.

FIGS. 5 and 6 show varying views the purge valve 10 of the present invention. The purge valve top cap 12 is preferably large in size while the purge valve bottom cap 14 is preferably-smaller in size than the top cap 12. However, the top cap 12 may also be the same size or smaller than the bottom cap 14. When using the pool tile cleaning device 1, the user must depress the purge valve top cap 12 in order to permit air to enter the reservoir 25, which in turn allows cleanser/cleaning fluid to exit the reservoir 25 onto the cleaning head 3.

Next, FIG. 7 shows a side view of a metering valve 17 of the present invention. The metering valve 17 is designed such that when adjusted, a flow reducer 22 minimizes the amount of solution flow into the cleaning product pathway 6.

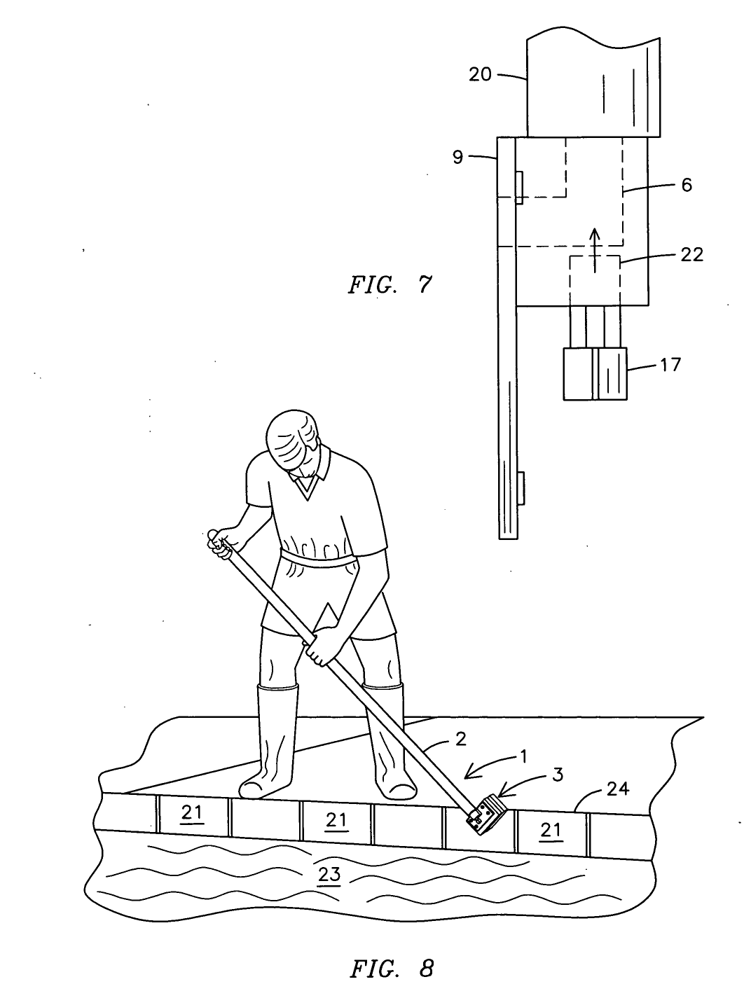

Finally, FIG. 8 shows a perspective view of the present invention in use on pool tiles 21. Because the handle 2 is elongated, a user need not get on his/her hands and knees in order to clean the tiles 21. He or she may simply remain a safe distance away from the pool edge 24 and place the cleaning head 3 of the pool tile cleaning device 1 against the pool tiles 22 to be cleaned. Because the cleaning product is direct distributed onto the cleaning head 3, the pool tile cleaning device 1 may be used within or out of the water 23.

In addition, a protective sheath may be secured to the handle 2 to reduce deterioration of the pool tile cleaning device 1 and possible damage to the pool edge during use.

The use of the present invention will allow persons to thoroughly clean pool tiles quickly and easily with minimal amount of physical discomfort and cleaning product waste.

Although the present invention is preferably used for the cleaning of pool tiles, the present invention may also be used on a variety of other surfaces.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A pool tile cleaning device comprising:
an elongated hollow handle having a proximal end and a distal end;
a cleaning head attachable to said distal end of said handle;
a metering valve located on said distal end of said handle; and
a means for allowing air to enter said handle.

2. The pool tile cleaning device of claim 1 wherein:
said means for allowing air to enter said handle is a purge valve.

3. The pool tile cleaning device of claim 2 further comprising:
a means for attaching said purge valve to said handle proximal end.

4. The pool tile cleaning device of claim 3 wherein:
said means for attaching said purge valve to said handle proximal end is by threads;
said handle proximal end is threaded; and
said threads on said purge valve correspond to said threaded handle proximal end.

5. The pool tile cleaning device of claim 1 wherein:
said cleaning head is a scrubbing pad.

6. The pool tile cleaning device of claim 1 further comprising:
a means for attaching said proximal end of the handle to a hose.

7. The pool tile cleaning device of claim 6 wherein:
said means for attaching the proximal end of the handle to said hose is by threads; and
said threads correspond to threads on said hose.

8. A pool tile cleaning device comprising:
an elongated hollow handle having a proximal end and a distal end;
a cleaning head attachable to said distal end of said handle;
a metering valve located on said distal end of said handle;
a means for allowing air to enter said handle;
said means for allowing air to enter said handle is a purge valve;
a means for attaching said purge valve to said handle proximal end;
said means for attaching said purge valve to said handle proximal end is by threads;
said handle proximal end is threaded; and
said threads on said purge valve correspond to said threaded handle proximal end.

9. The pool tile cleaning device of claim 8 further comprising:
a means for attaching said handle proximal end to a hose;
said handle proximal end is threaded; and
said means for attaching said handle proximal end to said hose is rotatably attaching threads on the handle to threads on said hose.

10. A method for using a pool tile cleaning device comprising an elongated hollow handle having a proximal end and a distal end; a cleaning head attachable to said distal end of said handle; a metering valve located on said distal end of said handle; and a means for allowing air to enter said handle, said method comprising the steps of:
a. attaching said handle top to said cleaning head;
b. adjusting said metering valve to provide for a desired flow of cleaning solution onto the cleaning head;
c. placing said cleaning head against a surface; and
d. scrubbing said surface.

11. The method of claim 10 further comprising a step prior to step b of: adding a cleaning product into said hollow handle.
